(19) United States
(12) Patent Application Publication
(10) Pub. No.: US 2023/0199925 A1
(43) Pub. Date: Jun. 22, 2023

(54) COSMETIC LIGHT

(71) Applicant: COSMOGLO LLC, Hernosa Beach, CA (US)

(72) Inventor: Mary HARCOURT, Hermosa Beach, CA (US)

(21) Appl. No.: 18/008,295

(22) PCT Filed: Apr. 30, 2021
(86) PCT No.: PCT/US21/30259

§ 371 Date: Dec. 5, 2022

(51) Int. Cl. H05B 45/10; A45D 44/02; F21V 21/30; F21V 21/22; F21S 6/00

(52) U.S. Cl. CPC H05B 45/10; A45D 44/02; F21V 21/30; F21V 21/22; F21S 6/004; F21Y 2115/10

(57) ABSTRACT

Embodiments of the present invention provide a light emitting diode (LED) lighting fixture and methods of manufacturing and using the same. In various embodiments, the LED lighting fixture comprises a lighting fixture body and one or more lighting arch. The one or more LED modules are operatively and securely fixed to the lighting assembly. Each LED module comprises at least one LED, and a diffuser. The at least one LED is mounted within the LED light assembly such that light emitted by the at least on LED is emitted in a downward direction. The light assembly is positioned such that it can rotate about a fixed point to facilitate a user working on a patient's face. The light assembly is further adjustable in elevation from approximately 30 inches to 60 inches in height above a floor.

### CROSS-REFERENCE TO RELATED APPLICATION

The present application claims is a US National Phase application and claims priority to and benefit of PCT application PCT/US21/30259 filed Apr. 30, 2021 and claims priority to and the benefit of U.S. design patent application Ser. No. 29/733,460, filed May 1, 2020, the contents of which as are hereby incorporated by reference in their entirety.

### BACKGROUND

The cosmetics industry is always innovating and the eyelash market is no different. With the recent surge in ZOOM® meetings and remote meetings people are trying to put their best foot forward. In response, the industry has developed ever cheaper and cheaper LED light products with the culmination of the ring light as the current state of the art. As styles ebb and flow ring lights have put the spotlight on acute facial defects. Many artists are able to use light and color to improve appearance in many environments. However, there is a necessity for the artist to work in realistic environments where a client will be viewed in many lights and many perspectives. Recent advances in manufacturing light emitting diodes (LEDs) combined with the efficiency and long lifetime of LEDs have led to an increase in the availability and affordability of LED lamps. LED lamps offer advantages over compact fluorescent bulbs including longer lifetime and the absence of dangerous gasses. Also, LE D lamps may be configured to emit light at a wide variety of color temperatures.

The present use of ring lights is good but not the best. Therefore, care must be taken to diffuse LED lights and to balance LED lights. Lighting assemblies that emit LED light in a single direction that is appropriate for the lighting fixture and/or application is important, but it must also be balanced. This may result in a lighting fixture which is not aesthetically pleasing. Ring style LED lighting fixtures tend to have the LEDs that are overpowering and take away an artist's ability to view their client's face as a canvas.

Additionally, the form factor and use of the ring light is limiting. In a salon setting, a relatively heavy and permanently fixed light setup can be very efficient for client turnover on the same bed. Having a lighting assembly with a fixed placement in the salon, yet having the flexibility to raise, lower, and rotate light with confidence increases the artist's confidence and ability to work on their canvass.

### RELEVANT ART REFERENCES

Various decorative illuminated objects are known in the art, which display one or more lighting effects. For example, U.S. Pat. No. 6,801,003 discloses lighting systems for swimming pools, wall-mounted lighting systems, and window-mounted light-systems that include a processor that is configured to control a color-changing lighting effect generated by the lighting apparatus. The lighting system may also include memory storing one or more lighting programs and/or data. The lighting systems may also include a user interface used to change and/or select the lighting effects generated by the lighting system. The lighting system also discloses that the lighting system may be provided with a plurality of LEDs controlled such that the light outputs from two or more of the LEDs combine to produce a mixed colored light, and that the lighting system may be used in a variety of larger scale applications such as indoor and outdoor displays, decorative illumination, and special effects illumination.

U.S. Pat. No. 6,536,914 discloses an illumination system for illuminating a display device, comprising a light-emitting panel having at least one edge surface for coupling light into the light-emitting panel. The illumination system further comprises a light source comprising a plurality of clusters of light-emitting diodes, each cluster includes one blue, one green, and one red LED.

U.S. Pat. No. 10,711,991 discloses embodiments of a light emitting diode (LED) lighting fixture and methods of manufacturing the same. In various embodiments, the LED lighting fixture comprises a lighting fixture body and one or more luminaires. The one or more LED modules are operatively and securely fixed to the lighting fixture body. Each LED module comprises at least one LED, and a heat sink. The at least one LED is mounted within the LED module such that light emitted by the at least on LED is emitted in an upward direction. The heat sink is positioned such that at least a portion of the light emitted by the at least one LED is not incident upon the heat sink. Additionally, the heat sink is permanently fixed to the lighting fixture body.

US publication no. 20130265766A1 discloses a light stand assembly with a base having pivoting legs and a power supply circuit. An adjustable post detachably connects to the base. The adjustable post is configured for telescoping movement between a lower position and a raised position, and secures at a selected position with latches. An adjustable post connector moveably connects to the adjustable post. A pair of light modules detachably connect to the adjustable post connector and operatively connects to the power supply circuit.

### BRIEF DESCRIPTION OF THE DRAWINGS

FIG. 1 Shows a front oblique view of a preferred embodiment of the present invention.

FIG. 2 Shows a back oblique view of a preferred embodiment of the present invention.

FIG. 3 Shows an upward front oblique view of a preferred embodiment of the present invention.

FIG. 4 Shows an exploded view of a preferred embodiment of the present invention.

FIG. 5 Shows an exploded view of light assembly embodiment of the present invention.

### SUMMARY OF THE INVENTION

In various embodiments, the present invention provides a safe, simple, and aesthetically pleasing lighting assembly that utilizes one or more LEDs as the light source. The lighting assembly may comprise one or more LED light engines or LED modules that are configured to efficiently dissipate the heat generated by the one or more LEDs mounted within each LEI) module. In various embodiments, the lighting assembly is adjustable from a height of 30-60 inches. In various embodiments, the LED modules may be an integrated part of the lighting fixture. Additionally, the lighting assembly may have a heavy base to allow the positioning of the light assembly in a fixed manner.

This invention fulfills a need to provide an improved light and ergonomic light assembly for a user to apply cosmetics and perform facial procedures such as lash extensions.

Various improvements of the present invention may be apparent to those skilled in the art.

### DETAILED DESCRIPTION OF THE DRAWINGS

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

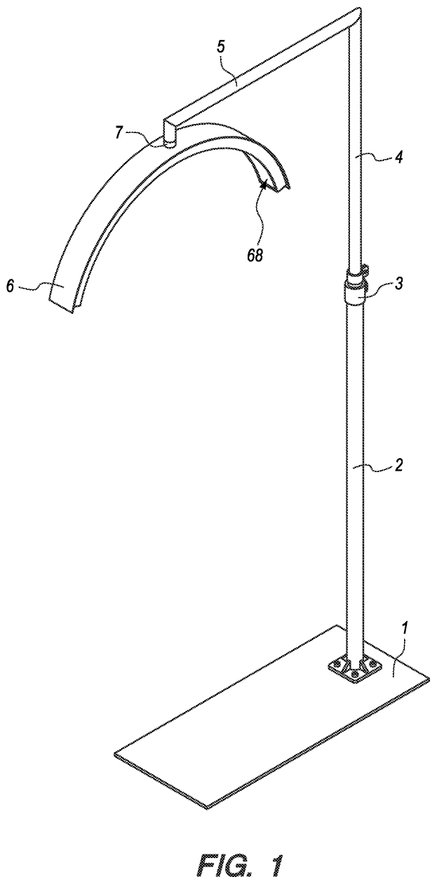

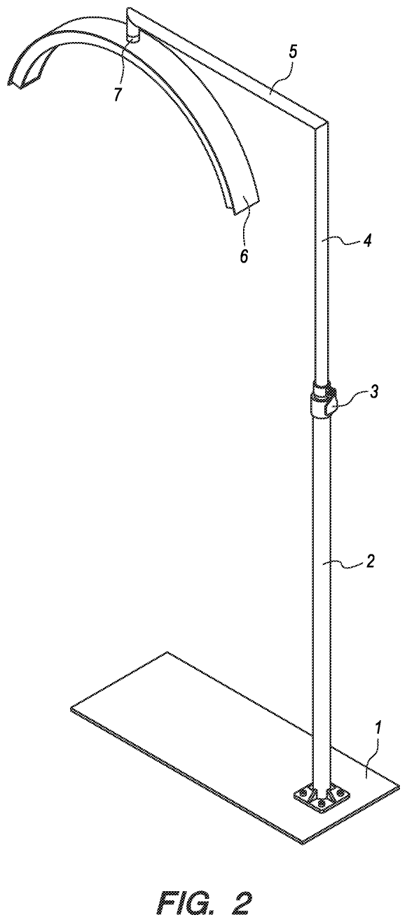

FIGS. 1 and 2 show a preferred embodiment of light device 10. FIGS. 1 and 2 illustrate a salon lantern style LED lighting device 10. In various embodiments, the LED lighting device 10 may be configured for salon or at home use. Lighting device 10 comprises a base 1, a telescoping base assembly 2, telescoping hardware 3, a telescoping top assembly 4, an upper stand assembly 5, light assembly 6, and a swivel head assembly 7. In an alternative embodiment the light device 10 optionally has a pivot point 8.

The base 1 in the preferred embodiment is six inches wide by 12 inches long with a thickness of three-quarters of an inch and weighing twelve pounds. The base 1 is made of steel however, it can easily be made of aluminum or other cast metals readily. The purpose of the base 1 is to provide a steady platform for a user to manipulate the lighting assembly 6 without fearing that the lighting device will topple over from a high center of gravity. The base 1 can have feet 11 integrated into the base 1 or affixed via adhesive or other mechanical attachment mechanism such as screws. The feet 11 in the preferred embodiment are comprised of a rubber material with anti-slip friction type surface to keep the lighting device 10 from sliding on a smooth surface. The pivot point 8 is a connection between the telescoping top assembly 4 and upper stand assembly 5 where in the upper stand assembly 5 can rotate around the telescoping top assembly axis.

The telescoping base assembly 2 in a preferred embodiment is attached to the base 1 and serves as a vertical scaffold for the telescoping top assembly 4. The telescoping base assembly 2 and upper stand assembly are connected with an adjustable telescoping hardware 3. The telescoping base assembly 2 and upper stand assembly are made of steel but could readily be made of aluminum, cast metals, or strong polymeric materials. The base 1 in a preferred embodiment is made of steel and weighs between 8-20 pounds to add to the stability of the overall lighting device 10.

The telescoping base assembly 2 is fixed to the base 1 and the telescoping top assembly 4 can be slid up or down relative to the telescoping base assembly 2 to adjust the overall height of the lighting assembly 6. A user of the lighting device 10 can fix the height of the lighting assembly 6 by tightening the telescoping hardware 3. The telescoping hardware 3 applies pressure over the telescoping top assembly 4 to create friction with telescoping base assembly 2. While the telescoping base assembly 2 in the preferred embodiment is 36 inches applications for taller or shorter settings are understood as easily adaptable alternatives. For example, salons for tall clients could have longer telescoping base assembly 2 up to about 60 inches. The telescoping top assembly 4 can vary in length with a preferred length of 28 inches but easily accommodate lengths of up to 60 inches in alternative embodiments. It should be readily apparent that the total height of the lighting assembly 6 is a combination of the telescoping base assembly 2 and telescoping top assembly 4 with a maximum height being limited by the combination of lengths. In order for the telescoping hardware 3 to operate properly, the telescoping top assembly 4 must overlap with a portion of the telescoping base assembly 2. The portion of overlap can be as little as one inch in the preferred embodiment although additional overlap will improve the stability of the lighting assembly device 10. In an alternative embodiment telescoping hardware 3 applies pressure over the telescoping base assembly 2 to create friction with the telescoping top assembly 4. The telescoping hardware 3 generally operates with a twisting motion to create friction; however, it is possible to incorporate a cam with a thumb switch similar to a quick release used on bicycle wheels as a mechanism to lighten and loosen the telescoping top assembly 4 to the telescoping base assembly 2.

In the preferred embodiment the telescoping top assembly 4 is fixedly attached to the upper stand assembly 5 via a right-angle attachment, thus the upper stand assembly 5 generally extends in a horizontal plane. The right-angle attachment 8 in the preferred embodiment is a weld between the upper stand assembly 5 and telescoping top assembly 4. In an alternative embodiment the right-angle attachment could be adjustable so that the upper stand assembly 5 could swivel or rotate relative to the telescoping top assembly 4. The ability to rotate the upper stand assembly 5 would allow a user an additional degree of freedom to move the lighting assembly 6.

The upper stand assembly 5 is further connected to the lighting assembly 6 in the preferred embodiment via a swivel head assembly 7. The swivel head assembly 7 allows a user to rotate the lighting assembly 6 in a generally horizontal plane to light the face of a client in an optimal manner for aesthetic procedures. The swivel head assembly 7 in the preferred embodiment can rotate freely. In an alternative embodiment the swivel head assembly 7 can incorporate mechanical locks to hold the lighting assembly 6 in a fixed position. Further, in the alternative embodiments the mechanical locking mechanism can incorporate saw tooth shaped or U-shaped complementary structures in the swivel head assembly that can be separated to allow the lighting assembly 6 to rotate and when the user determines a specific lighting assembly 6 position the user can release or push the swivel head complementary surfaces together thus causing a friction fit so that the swivel head assembly will not be able to rotate freely relative to the upper stand assembly 5. The upper stand assembly 5 in the preferred embodiment is 21 inches but in additional preferred embodiments the upper stand assembly 5 can range between 10-30 inches in length.

The lighting device 10 can be used to maneuver the lighting assembly 6 in three-dimensional space to provide light for the user in myriad positions.

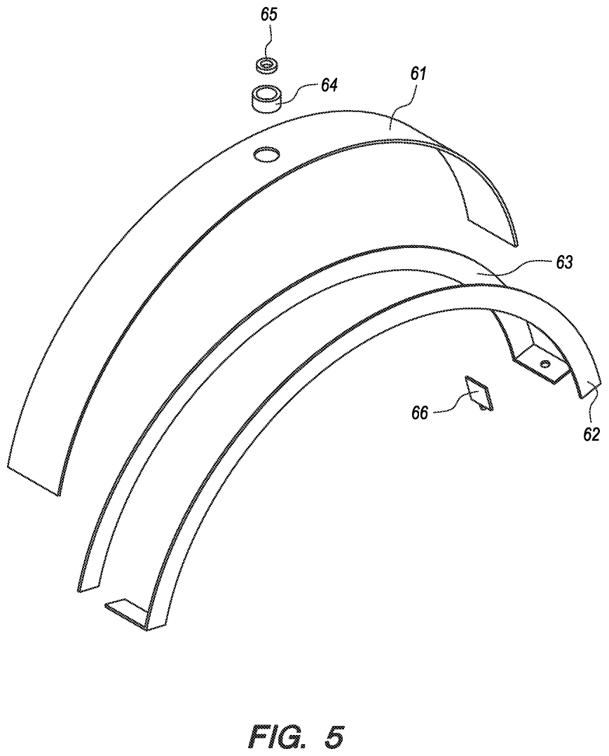

FIG. 5 illustrates an exploded view of the lighting assembly 6 and portions of the swivel head assembly 7. More specifically, the lighting assembly 6 comprises light top 61, a light assembly left side 62, and a light assembly right side 63 wherein LEDs are incorporated or attached to the light top 61 to provide light. When fully assembled a diffuser 68 would be attached to the light assembly left side 62 and a light assembly right side 63 to diffuse light emitted from LEDs. The lighting assembly 6 further comprises a dimmer control 66 disposed on the inside of the lighting assembly 6 and a control knob 67 disposed on the outside of the lighting assembly 6. A user can actuate the level of light emitted from LEDs by turning the control knob 67 which interfaces with the dimmer control 66 to regulate the light from the LEDs. The light assembly left side 62 and the light assembly right side 63 are complementary and made of non-transparent material such as metal or plastic. The light assembly left side 62 and the light assembly right side 63 in a preferred embodiment create spacing between the top light 61 and diffuser 68 of three-quarters of an inch. The space between the top light 61 and diffuser 68 in alternative embodiments can be 0.3 inches to 2.0 inches.

For the sake of clarity, a circular tube 64 and circular steel insert 65 show a portion of the swivel head assembly to allow for a little clearance between the lighting assembly 6 and upper stand assembly 5 when the lighting assembly 6 is rotated. The axial length of the circular tube 64 and circular steel insert 65 is preferably less than one inch and more preferably less than one half of an inch.

Diffuser 68 is a transparent to semi-transparent plastic capable of blending light from LEDs to smooth out light intensity from the top light 61. The distance between the top light 61 and diffuser 68 can be used to optimize light diffusion and blending. Further, the sides of the light assembly can be decorated or branded with markings for various purposes.

The structural materials for the telescoping base 2, telescoping top assembly 4, and upper assembly 5 in a preferred embodiment are half inch diameter steel tubing. In an alternative embodiment the tubing dimensions could have various wall thicknesses to support the lighting assembly 6 from 0.05 inch to one-quarter inch thick. The tubing diameter could be as thin as one-quarter inch or as thick as one-inch for metal and even larger diameters are contemplated for polymeric tubes made of PVC, ABS, or other commercially available HDPE or structurally rated polymers strong enough to support a five pound lighting assembly 6.

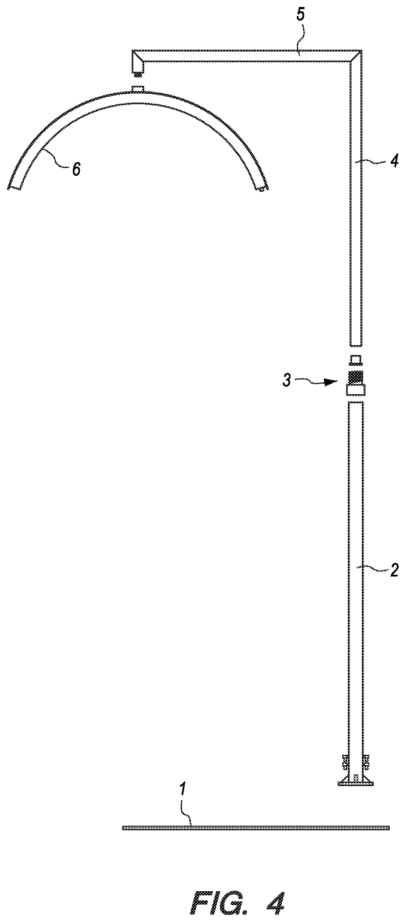

FIG. 4 illustrates an exploded view of a preferred embodiment of a lighting device 10. In the preferred embodiment the telescoping bottom assembly 2 and telescoping top assembly 4 are made of circular tubing or that can slide past each other so that the overall height of the lighting device 10 can be adjusted up or down.

The lighting device 10 may also be configured to hide the wires used to electrically connect the lighting assembly 6 to a power source.

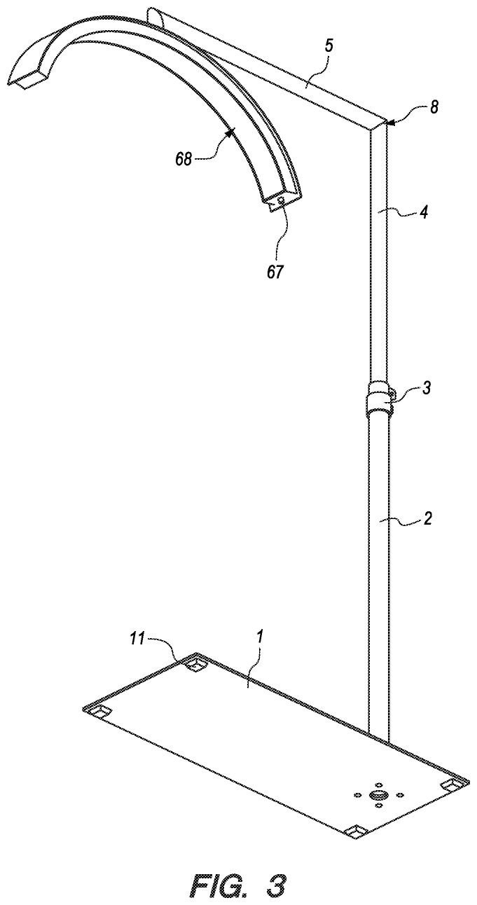

FIG. 3 The base 1 may be configured to hide and/or add a decorative aspect to a power cord that is configured to connect the lighting device 10 to an electrical power source. The base 1 may be further configured to provide a decorative aspect to the lighting device 10. FIG. 3 Further illustrates feet 11 that can be made of hard or soft polymer or rubber to stabilize the base 1 and prevent movement of the lighting device 10 on smooth surfaced flooring.

### Lighting Assembly 6

Each lighting device 10, includes one or more LED. FIG. 4 provides a close up of a Lighting assembly 6, according to one embodiment of the present invention. In various embodiments, at least one LED may be secured in each Lighting assembly 6. It should be noted that the present invention allows for the at least one LED to be mounted within the lighting assembly 6 such that light is emitted down through the diffuser 68.

The lighting assembly 6 in a preferred embodiment will have a length or span of 24 inches and a height of 12 inches in the shape of an arch or semi-circle. In an alternative preferred embodiment, the lighting assembly 6 will have a length or span between 15 to 30 inches and a height of between 5 to 18 inches. Although the preferred embodiment is a semi-circular shape, an alternative embodiment could utilize straight runs of the top light to form the top portion of an octagon or more. For example, if the top light 61 is 30 inches in total length, ten 3 inch runs with equal angles of approximately 300 degrees would create a similar arch shape but without a smooth appearance. In a preferred embodiment the width of the top light 61 is one and a half inches. In alternative embodiments the width of the top light 61 is between 0.5-4.0 inches. The LED power in the preferred embodiment is 12 watts that puts out about 1200 lumen in the 5000K color range. In an alternative embodiment the power LED power could be in the range of 6 to 24 watts with a maximum lumen out put of about 600 to 2400 lumen in the 5000K color range. Since a user can actuate the level of light emitted from LEDs by turning the control knob 67 which interfaces with the dimmer control 66 to regulate the light from the LEDs the working lumen in the preferred embodiment is 100-1200 lumen.

Additional modifications and improvements of the present invention may also be apparent to those skilled in the art. Thus, the particular combination of parts described and illustrated herein is intended to represent only one embodiment of the invention, and is not intended to serve as a limitation of alternative devices within the spirit and scope of the invention. The term telescoping should be understood that a tube with a fixed outer diameter can freely slide up and down or twist within a tube with a nearly identical inner diameter. LED lights are understood in the lighting industry and myriad LED lights are commercially available in various temperature ranges from 2700-5000K in white lights. Additionally, LED lights are well known to be capable of producing colored light in the 400-700 nanometer range.

I claim:

1. A lighting device comprising:
a base with a telescoping base assembly connected to a telescoping upper assembly with an adjustable telescoping hardware, and the telescoping upper assembly is further attached to an upper stand assembly wherein the upper stand assembly is connected to a lighting assembly with a swivel head assembly; the lighting assembly configured with LEDs and capable of freely rotating and wherein the lighting assembly further comprises a control knob to adjust total lumen output with a dimmer control.

2. The lighting device of claim 1, wherein the lighting assembly is comprised of a top light with LEDs, a light assembly left side assembly and a light assembly right side that create a distance between a light diffuser and the top light.

3. The lighting device of claim 1, wherein the top light is arch shaped with a length of twenty-four inches and a height of twelve inches.

4. The lighting device of claim 3, wherein the diffuser has decorative features.

5. The lighting device of claim 1, wherein the base has feet.

6. The lighting device of claim 1, wherein the upper stand assembly is capable of height adjustment between 30-60 inches.

7. A lighting device of claim 1, wherein the telescoping top assembly is connected to the upper strand assembly with a pivot point.

8. The lighting device of claim 3, wherein the top light LEDs produce between 600-1200 lumen.

9. The lighting device of claim 3, wherein the top light LEDs are configured to change color between 400-700 nanometer.

10. The lighting device of claim 1, wherein the lighting assembly is configured for indoor or outdoor use.
